(19) United States
(12) Patent Application Publication
(10) Pub. No.: US 2010/0243580 A1
(43) Pub. Date: Sep. 30, 2010

(54) HYPEROXIDATION ADVANCED OXIDATIVE TREATMENT OF WATER

(76) Inventor: Mark Richard Lobban, South Australia (AU)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/679,368

(22) PCT Filed: Sep. 19, 2008
(86) PCT No.: PCT/AU2008/001393

§ 371 Date: May 21, 2010

(30) Foreign Application Priority Data
Sep. 21, 2007 (AU) 2007905174

(51) Int. Cl. C02F 1/78

(52) U.S. Cl. 210/760; 210/198.1

(57) ABSTRACT

An apparatus for the purification of polluted and/or waste liquids utilizing an oxidative treatment of said polluted and/or waste liquids, said apparatus including a first container adapted to effect recirculation of the liquid while in the first container so that a head space is maintained above the liquid within the first container; said recirculating liquid being drawn from the first container and being reintroduced into the first container through each of at least two jets aligned and positioned to direct said jets flow of liquid, so that this flow will impact against incoming liquid from at least one other of the jets; means for introducing ozone into the recirculating liquid; means for drawing the treated liquid from the first container; wherein each jet including air suction means with an arrangement to integrate such sucked air into the liquid passing through the jet such that the air suction for each jet being connected and effecting a draw of such air from the head space within the container.

### FIELD OF THE INVENTION

This invention relates to advanced oxidative treatment to clean or purify water from a variety of sources and waste liquids to higher standards of quality as well as an apparatus for effecting an oxidated treatment of water from a variety of sources and waste liquids, and also is directed to the resultant liquid which has been treated according to the method or by the apparatus.

### BACKGROUND ART

Purifying a variety of water sources for use and recovery re-use and recycling of water is becoming increasing important for conservation of water sources and especially the ability to adequately treat water with great efficiency and therefore lesser cost.

It is known to use and introduce ozone and/or oxygen into water during a treatment process to assist in the purification process.

It is also known that ozone once introduced into water will remain effective for only a relatively short time and that the apparatus to which ozone must be introduced to the liquids needs to be of considerable size and the volume of ozone to be used, if ozone is going to be effective, will be by no means insignificant.

Therefore there remains a requirement in this field of technology to come up with an improved oxidative treatment method and apparatus that is able to clean or purify water from a variety of sources and waste liquids to higher standards of quality, utilizing ozone more efficiently with an apparatus less complicated and sized by design.

### SUMMARY OF THE INVENTION

Throughout this specification the term air is defined generally as a gaseous mixture per se, rather than air exclusively per se that one may associate with the air human's breath about the place for their existence.

Accordingly in one form of the invention there is provided a method for oxidative treatment of waste liquids including the steps of introducing liquid to be treated into a container, effecting recirculation of the liquid while in the container so that a head space is maintained above the liquid within the first container, the recirculating liquid being drawn from the container and being reintroduced into the container through each of at least two jets aligned and positioned to direct its flow of liquid so that this flow will impact against incoming liquid from at least one other of the jets, and each jet including air suction means with an arrangement to integrate such sucked air into the liquid passing through the jet, the air suction for each jet being connected and effecting a draw of such air from the head space within the container, and means introducing ozone into the recirculating liquid, then drawing such treated liquid from the container.

In a further form of the invention there is provided an apparatus for the purification of polluted and/or waste liquids utilizing an oxidative treatment of said polluted and/or waste liquids, said apparatus including:

a first container adapted to effect recirculation of the liquid while in the first container so that a head space is maintained above the liquid within the first container;

said recirculating liquid being drawn from the first container and being reintroduced into the first container through each of at least two jets aligned and positioned to direct said jets flow of liquid, so that this flow will impact against incoming liquid from at least one other of the jets;

means for introducing ozone into the recirculating liquid;

means for drawing the treated liquid from the first container;

wherein each jet including air suction means with an arrangement to integrate such sucked air into the liquid passing through the jet such that the air suction for each jet being connected and effecting a draw of such air from the head space within the container.

In preference the apparatus further includes means for introducing hydrogen peroxide and/or a coagulated polymer into the recirculating liquid.

In preference the polymer is poly aluminium chloride.

Preferably there is automatic dosing of liquid coagulated polymer, or hydrogen peroxide or, acid or alkali to adjust pH if necessary to 6.5 and above. Preferably this occurs into incoming flow, and can be manually or automatically dosed into source liquid.

Preferably in one form of the invention the above method further includes introducing the liquid then first treated in the first said container into a second container, effecting recirculation of the liquid while in the second container so that a head space is maintained above the liquid within the second container, the recirculating liquid being drawn from the second container and reintroduced into the second container through each of two jets aligned to effect a contra flow one against the other of the liquid with respect to each jet of liquid, and each jet including air suction means with an arrangement to integrate such sucked air into the liquid passing through the jet, the air suction for each jet being connected and effecting a draw of such air from the head space within the container, and means introducing both hydrogen peroxide, ozone and/or a polymer into the recirculating liquid of the second container, then drawing such treated liquid from the second container.

In preference the apparatus further includes a second container, said second container adapted to receive treated water from said first container, said second container having means to effect recirculation of the liquid while in the second container so that a head space is maintained above the liquid within the second container, the recirculating liquid being drawn from the second container and reintroduced into the second container through each of two jets aligned to effect a contra flow one against the other of the liquid with respect to each jet of liquid, and each jet including air suction means with an arrangement to integrate such sucked air into the liquid passing through the jet, the air suction for each jet being connected and effecting a draw of such air from the head space within the container, and means introducing hydrogen peroxide, ozone and/or a polymer into the recirculating liquid of the second container, then drawing such treated liquid from the second container.

Advantageously if one establishes a head space within a container above liquid being treated, and draws air from such head space into a jet activator introducing liquid back into liquid in the container, then, by essentially recycling released ozone in such a head space, significantly assists in the treatment process and better utilizes the ozone.

One of the problems with earlier arrangements is the need to sufficiently agitate the water in contact with the ozone, but advantageously with this invention it has been found to be of tremendous benefit to have at least two jets arranged to return water being treated into the container but the jets being aligned so that they are directed to effect their output into a colliding path with the water being directed from one or other of the further jets.

In preference the jets are located at the top of the or each container within the respective head space or spaces above the liquid level.

Preferably the jet outlets are aligned such that the respective discharges collide with a vertical downwards angle.

Advantageously the collision produces excellent agitation and mixing of water and valuable air gasses to oxidise and unpollute the water. Ozone and all oxygen rich air that comes out of solution is sucked by the jets from inside top of container in the created head space and returned into incoming water into container.

Preferably a baffle plate is located at bottom of the or each container to bounce bubbles of gas upwards and prevent gas build up from high volume air bubbles.

As the respective flows collide the agitation and the like creates lots of bubbles of which some may contain unused ozone. Advantageously the bubbles hit the baffles and rise up to be released and then reabsorbed by the jet back into the recirculating water.

Preferably the or each container includes a liquid level sensor to maintain the head space within the respective container.

Preferably liquid level in the or each container would be around 80% of container volume until discharge.

Advantageously such an arrangement maintains effective air gas volume to be sucked by the jets to effect into incoming liquid flow into the container.

Preferably the liquid is recirculated through sand or zeolite filtration, preferably backwashable filter or a non backwashing filter cartridge.

Advantageously the filtration media and physically break down air/gas

Bubble sizes causing excellent dissolving efficiency into fluid. The backwashing filters can be manually or automatically backwashed when pressure in filters rises from solids accumulation.

Preferably automatic valves maintain the fluid recirculation flow direction until by predetermined time in process control or measured water quality by analysis probe purified liquid is directed through activated carbon out to storage and distribution. Activated carbon reduces ozone content and polishes water to higher standard of quality.

In preference the apparatus further includes a cyclonic filter in either recirculation loop or inflowing liquid to separate suspended solids and reduce solids loading on sand/or zeolite filter and is either automatically flushed with inflow water either manually or automatically.

In preference the jets are venturi aspirators

In a further form of this invention in the alternative this can be further said to reside in a method of advanced oxidative treatment of waste liquids as preceding wherein air in the head space is drawn from the head space down through a conduit into an air inlet of a respective jet, the conduit being shaped with a narrowing cross sectional area from its inlet in the head space to the jet such that air being drawn through this is induced to be a vortex.

In a further form of this invention in the alternative this can be further said to reside in a method of advanced oxidative treatment of waste liquids as in at least some, of preceding paragraphs wherein each jet is positioned to be located to introduce its fluid at or close to a lower most position within the container.

Preferably the apparatus for the purification of polluted and/or waste liquids utilizing an oxidative treatment of said polluted and/or waste liquids includes two airtight conical base, cylindrical containers, each with a recirculation outlet at the base of the cone.

Preferably to prevent the escape of air, a sealed access lid is provided at the top centre of the containers. The containers as well as pipes, seals, junctions and other fitting in contact with fluids or air are made of oxidant resistant material such as 316 marine grade stainless steel or stable oxidation resistant polymer material to withstand intensified levels of oxidising agents over time.

Preferably the containers have fluid level sensors limiting the upper fluid level automatically to a preset maximum height within the container. The upper fluid level controls a predetermined airspace. The controlled air-space contains a known volume of air comprising the gasses released from the fluid and existent air within that space.

Preferably the pumps and automation control program used to control movement of fluids, gasses and oxidants through the system are computerised automatic process logic controlled (PLC). Each pump is controlled from the central processor with infinitely variable speed drives. The speed of the pump moderates the flow and pressure in the system optimising the balance between energy consumption and fluid movement. This assists to regulate the infusion of oxidising agents in the process in relation to flow rates and water quality requirements.

Preferably an external ozone generator with air drier and integrated molecular sieve is required to reduce nitrogen levels of the feed air and supply dry air with increased oxygen levels to increase the ozone concentration within the system for each container. A corona discharge type, or ozone generator with similar characteristic specifications, including a molecular sieve and integrated air drier will increase pure oxygen levels.

The spray of air gas mixture is highly turbulent, the water molecules are in small clusters and the available oxygen, ozone and hydroxyl radicals are optimised in availability for oxidation of organic matter, micro pollutants, bacteria, virus, petrochemicals, oils, pesticides, herbicides, detergents and colour causing agents or tannins into carbon dioxide, oxygen, mineral salt and water.

The spray from each venturi air water mixing outlets are directed to collide with each other with great agitation directed by force of water movement under pressure into the centre of the container submersed at the level just above the cone internally. The oxidation of ozone into hydroxyl radical and subsequent oxidation of pollutants is given maximum oxygen to support this reaction and maximum surface area to react with. The design of recirculation allow for this step to repeated again and again until analysis shows desired water quality is reached.

The suction venturi force provided by the fluid sucks the air gasses from the top of the container and mixes the concentrated air gasses with the fluid on re-entry to the container through the Venturi Aeration Device outlets. The air gasses and water mix are induced under a vacuum then becoming a pressurised spray at each fluid stream colliding at the centre of the container. Ozone that has not converted to hydroxyl radical is recycled from the air gap at the top of container back into the fluid in a dynamic repeated action. This encourages the maximisation of ozone utilisation and the oxidation effect on pollutants in the fluid from hydroxyl radicals created by ozone and hydrogen peroxide. The need to remove unspent ozone and destroy it with a conventionally utilised ozone destruction unit is eliminated and maximum oxidation is achieved whilst increasing the achieved oxidation effect per milligram or gram of ozone injected from the ozone generator. The air suction pipe is of larger diameter at the air inlet and smaller diameter at the venturi throat outlet.

As Oxygen is created from ozone O3 and hydrogen peroxide H2O2; OH (hydroxyl radical) is also created as a by-process; excess oxygen O2 is then able to react with water and contaminants. The gas mix then re-enters the Suction. Venturi Zone above the fluid and is repeatedly sucked through the venturi air pipe back into the fluid. Oxidation of pollutants from recirculated oxygen enhances the concentration providing the maximum utilisation of Hydroxyl radicals possible. The best location of maximum oxygen and potential unused ozone to oxidise pollutants is from the airspace at the top of the Systems Process Containers. Ambient air outside the container has lower concentration of ozone and is not used.

An alternative option in container one can be that a process logic controller calculates a measured meter dose of coagulation polymer, ozone or hydrogen peroxide into the venturi ozone induction zone into an additional controlled bypass loop on pipe immediately after the Vortex mixing Device or alternately immediately before the Vortex Mixing Device. This is standard in container two if such a further container is preferably used.

A calculated length and diameter of pipe coiled around the outside of the Systems Process Containers, or coiled within a cylindrical vessel will provide a measured contact area with an enhanced effect on the induction of the ozone into the fluid. Turbulence is engineered into the flow through vortex inducement throughout the pipe. This encourages a higher concentration of ozone gas mixing with the whole length of water flow through the spiral coiled aeration pipes. Ozone is not highly soluble and this flow dynamic enhances the efficiency of ozone dissolving into the fluid through the fluid mechanics of a fluid flow vortex over an extended journey. The coiled pipe of a measured length and internal diameter will enable the reaction time of ozone and hydrogen peroxide to form hydroxyl radicals within the pipe prior to re-entry back into the treatment container. This will enable the optimisation of the oxidation reaction of hydroxyl radicals with contaminants in the fluid whilst separated in transit through the loop external to container.

A greater dissipation of water molecules into smaller clusters encourages a to greater surface area providing for greater oxidation efficiency to occur within the systems process containers.

### DESCRIPTION OF THE DRAWINGS

For a better understanding of this invention it will now be described with embodiments illustrating the invention which shall be described with the assistance of drawings wherein:

FIG. 1 is a schematic view of functional elements of a first embodiment;

FIG. 1a is an extension of the view as in FIG. 1 illustrating more of the function units and some visually more explicit details again the first embodiment;

FIG. 2 is a plan view illustrating the alignment of venturi aspirators which system is applicable both to the first embodiment and to each of the containers in the second embodiment which will be later described;

FIG. 3 is a second embodiment which uses two containers and provides the differential dosing in respect of these individual containers;

FIG. 4 is a cross-sectional view of a sampling tube which is used again both in the first and second embodiments in each of the containers; and

FIG. 5 is a side view of this same sampling tube which as in FIG. 4 is used in both first and second embodiments.

FIG. 6 is a schematic cross-sectional view of a container wherein the venturi aspirators are located above the liquid level within the created head space.

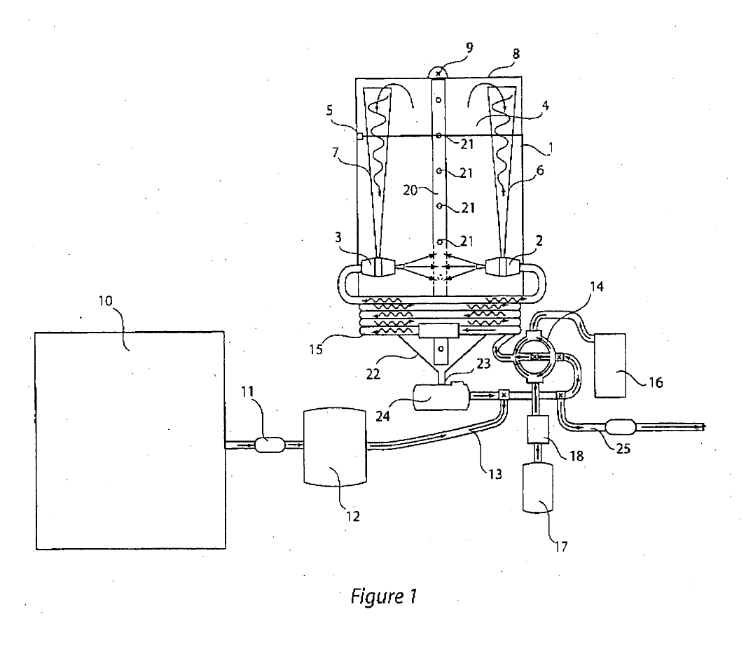

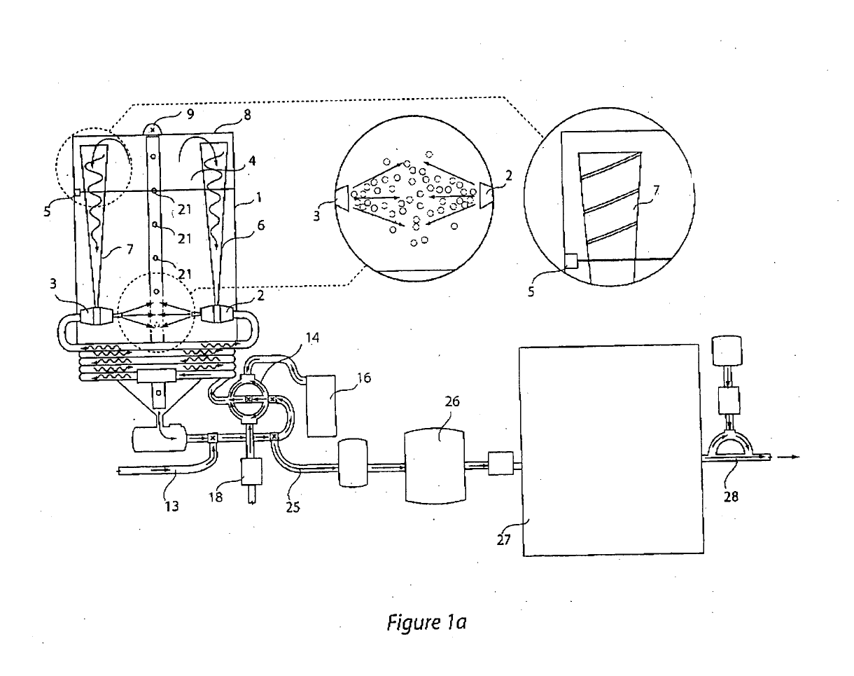

### DETAILED DESCRIPTION OF THE DRAWINGS

Referring now to the first embodiment, there is a treatment container 1 which is of cylindrical shape and positioned so as to have its cylindrical axis vertical.

Within the container 1 are two venturi aspirators 2 and 3 which are positioned so as to effect a colliding flow of returning liquid and entrained gases so that there is effectively a maximum of energy input and activity within the colliding zone.

A venturi aspirator draws air into liquid passing through it and being jetted into the container 1 and to this end, each venturi aspirator 2 and 3 in this case are positioned at a lower position within the container 1 so that liquid with air being jetted from these will then cause the air to naturally further rise through a remaining volume of the liquid.

The difficulty addressed here is that ozone which is, the first gas to be used in the advanced oxidative process is both expensive to obtain and equipment to provide it is also capital intensive.

We have therefore arranged that liquid height within the container 1 shall be maintained at a level which will enable a significant head space to be retained at the upper portion of the container 1.

There is a level detector 5 which is used to detect the level of liquid in the container and this is a type chosen to allow for turbulent water conditions.

Nonetheless, if a head space in this case of about ⅕ of the total volume is created and maintained, then it is found that it is reasonable to take the air which of course is receiving the ozone formally bubbling through the liquid and recirculate this ozone enriched air through conduits 6 and 7.

Each of these conduits 6 and 7 has an open uppermost top which is close to the roof 8 of the container 1 and is also shaped so that it is conical and in each case includes inwardly projecting vanes which assist in promoting a vortexing passage of ozone enriched air into the respective venturi aspirators 2 and 3.

By inducing a vortex at this stage, it is found that this significantly improves the mixing effect of the ozone enriched air and liquid being pumped through the venturi aspirator and assists further in energetic mixing of ozone and liquid.

In a further embodiment there are three venturi aspirators again positioned at a lower portion within a cylindrical container and each directed to effect a colliding jet flow one against the other and each drawing air from an upper head space with vortex inducement.

The actual number of aspirators is not of itself limited but thus far two have been found to provide effective and sufficient mixing and agitation of the water.

One aspect of this arrangement is that the air in the head space will become evacuated over a period and there is provided an air pressure relief valve 9 which is governed by a programmable logic computer which responds to pressure detected within the head space and upon a set lowering of such pressure, it effects a controlled extent of further air to be released in the head space.

In this way, the concept of recirculation of ozone is able to be achieved effectively and economically.

The apparatus is designed for batch treatment and to this end there is provided a storage container 10 to hold water to be treated, and there is a pump 11 arranged to effect passage of the fine filter 12 the liquid then being directed through conduit 13 into a mixing arrangement 14 from whence it is directed into coil 15 and then is directed into the respective venturi aspirators 2 and 3 in approximately equal volumes and pressure. An ozone generator 16 is arranged to direct its resultant ozone product into the mixing system 14 and as well, in this single container embodiment, there is a supply of hydrogen peroxide in container 17 which is dosed at a selected rate through dosing meter 18 which resultant product is also then directed into the mixing assembly 14.

Once the ozone and hydrogen peroxide have been introduced into the liquid, they are fed into the coil 15 the purpose of which is to provide for a long contact time between the gases and the liquid before being introduced through the venturi aspirators into the main mixing chamber.

Once there has been pumped sufficient liquid into the container 1 for the operation of oxidative treatment to commence, this is done so and there are probes which are positioned within conduit 20 which has a plurality of sampling holes 21 the purpose of which is to reduce turbulence within the conduit 20 and thereby allow for the probes which are variably positioned during the treatment process such that there is sufficient transfer of the liquid as its current status can be established within the holes without the turbulence and aeration itself causing confusion as to the ability to take stable readings.

The length of the coil 15 in this embodiment is 15 metres so it will be seen that it can be a substantial period of time maintaining close contact between gases and mixed materials in the liquid.

A bottom of the container 1 is of cone shape 22 so that all of the material within the container will be directed into a lowermost outlet conduit 23 from which recirculating pump 24 then redirects the liquid through the conduits through the mixing assembly 14 and then back through the coil 15.

As it was being described previously, the treatment process is a batch process in which a quantity of liquid is directed into the container 1 treatment contains for a period until the liquid is adjudged to be adequately treated, and it is then pumped through outlet conduit 25 a media filter 26, a storage container 27 and finally a polishing dose through a mixing assembly at 28.

Such further treatments for instance the further filter at 26 could be a carbon filter so as to give a final polish to the liquid coming from the treatment.

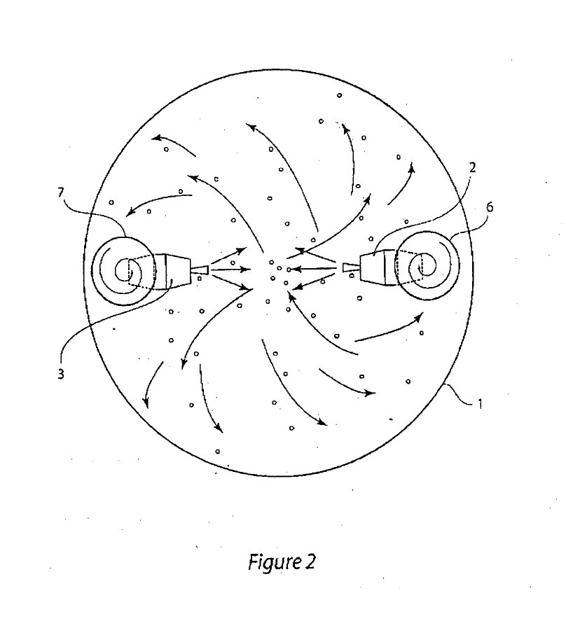

Now referring to FIG. 3, this differs from the first embodiment described by having two containers and having containers collectively held within an enclosure so that air that is drawn into the ozone generators or even into the air relief valve access, can then be of a status eg dry to assist in generation or not to aggravate the ozone further in the head space.

Further, by having two containers, a first in relation to the process is used for treating with ozone only and the second of these is then used to provide a dose both of ozone and hydrogen peroxide.

Referring in detail of FIG. 3 then, there are two containers 30 and 31 each of is which have two venturi aspirators shown at 32 and 33 in the case of container 30 and 34 and 35 in the case of container 31.

As with the first embodiment, each of these has a conduit shown at 36 through 39 each of these being of conical shape with a larger open mouth uppermost and the open mouth being at an upper location within the cylinders and being located within a head space 40 in the one case and 41 in the other which is kept to capture oxygen enriched or ozone enriched air emanating from the processing liquids within the body of the container at for instance 42 and 43 and in this way achieves significant economies of scale in and is able to promote advanced oxidative treatment processing of waste liquids.

The apparatus for each of the containers is substantially the same as in the first embodiment including a supply conduit from a storage at 44 passing through a fine filter mesh at 45 which is then directed into a conduit system feeding mixing conduit arrangement 46 which receives ozone from ozone generator 47 and other additives if required at 48.

Subsequent to the mixing assembly 46 there is a coil of long length to promote a close association of the liquid and gas in the coil 49 before being directed in the venturi aspirators 32 and 33.

There is a lowermost conical floor 50 feeding resultant liquid into an outlet conduit 51 which in turn then feeds recirculating pump 52.

The air relief valve 53 is also included controlled by a programmable logic controller so as to maintain an appropriate pressure with the head space 40.

The process here is intended to provide a first batch treatment of liquid which when it is deemed sufficiently treated with the ozone only, is then pumped through conduit 54 into the second system where again with container 31 there are the same elements including a conical floor 55, a recirculating pump 56, a coil to promote close association of the additives into the liquid at 57, and a hydrogen peroxide store and supplier at 59.

The treatment process itself will be described in greater detail following but the apparatus as now described is designed to take a first batch of liquid to introduce this to a sufficient level to maintain an adequate head space within the first container 30, mix this thorough with ozone and then when it is appropriately deemed to be sufficiently treated at this first stage, to then be introduced into the container 31 where there is joint dosing of ozone and hydrogen peroxide.

Once it is deemed that the treatment has gone far enough, the thus far then treated liquid is pumped through a finishing filter 60 to be directed to outside appropriate storage 61.

As with the first embodiment also, there is the sampling conduit 62 in one case and 63 in the other with a number of apertures at spaced apart locations through the vertical height of the conduit to allow for a limit of turbulence but also allowing a monitoring sensors to be lowered through the pipe to various heights to gain information as to the status.

A further feature is that in relation to the pumps each of these is chosen to be of a variable speed type and it is further featured then that the programmable logic controller can also ensure that an appropriate speed is chosen which optimises the efficiency of the process.

While it is not shown in the first embodiment, a surrounding containment chamber as is shown in FIG. 3 for embodiment 4 is of advantage this being shown at 64 with a representative air-conditioner 65 ensuring that air drawn either through the ozone generators 47 or 58 or the air relief valves at 53 or 66 can be assured of having relatively dry air which assists in the process.

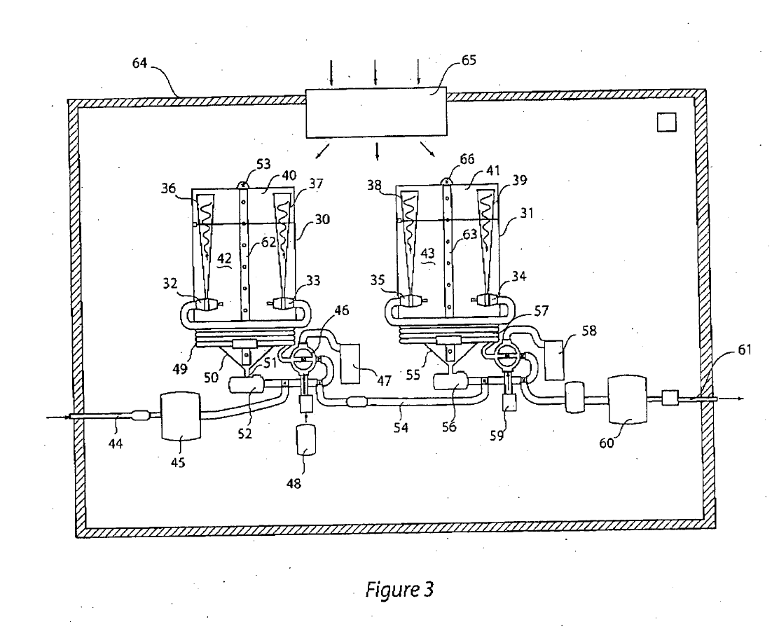

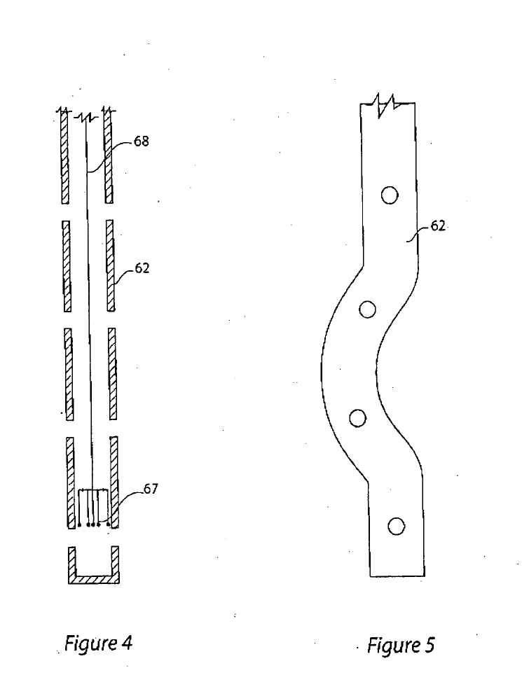

FIGS. 4 and 5 are views in greater detail of the access pipes 62 and 63 are shown in FIG. 3 and there is shown a number of sensors at 67 which are lowered by control cord 68 so that from time to time, the position of these can be varied thereby allowing for a sampling at all heights within the liquid being treated in the container.

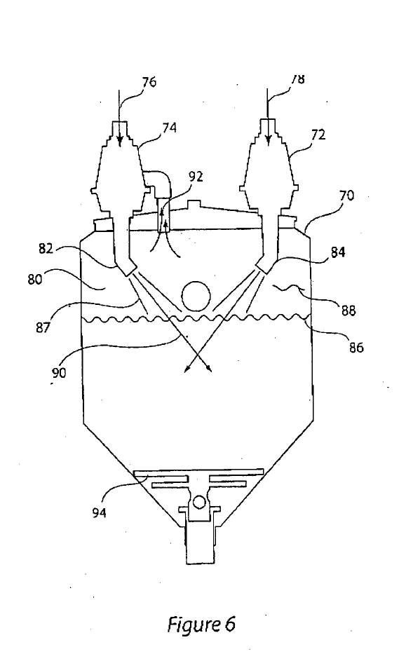

In FIG. 6 the venturi aspirators 72 and 74 are located at the top of the or each first and/or second container, which in FIG. 6 has the container shown as 70.

Venturi aspirators have the nozzles 82 and 84 within the respective head space 80 above the liquid level 86.

The nozzles 82 and 84 are aligned such that the respective discharges 87 and 88 collide with a vertical downwards angle shown generally as 90.

Advantageously the collision produces excellent agitation and mixing of liquid and valuable air gasses to oxidise and unpollute the water. Ozone and all oxygen rich air that comes out of solution is sucked by the venturi aspirators 82 and 84 from inside the container 92 from the created head space 80 and returned into incoming liquid 76 and 78.

There is also shown of FIG. 6 a baffle plate 94 located at bottom container 70 to bounce bubbles of gas upwards.

Further comments in relation to the processing now and explanations which will be of assistance in understanding the method of use and apparatus presented.

Firstly liquid waste to be treated is in this case primarily filtered through a backwashing media filter which in this case is zelbrite-zeolite being 5 microns nominal.

A foot valve is utilised and positioned prior to a T-junction fitting to prevent backflow and not affect operation efficiency of the recirculating pump.

The liquid waste is introduced into the recirculation coil pipe there are vortex mixer positioned 30 metres inline prior to the outlets to the two venturi aspirators.

When low level sensor senses a minimum volume for treatment, this is commenced.

The ozone generator used in each case is also combined with a moleculous sieve to increase input oxygen level to 95% or greater for more efficient production of ozone than can be obtained from simply ambient air.

Ozone generators being used in this particular embodiment are capable of providing 30 grams per hour.

In relation to the second embodiment, ozone is known to remain dissolved in water for up to 20 minutes. This allows ozone to treat the waste water initially then residue ozone in the liquid and initiated hydroxyl radical activity from that stage is transferred into the second stage treatment container and is hit by ozone hydrogen peroxide mixed to form hydroxyl radicals in the second container.

As hydroxyl radicals have a life of only up to 1 second, it is of greater benefit to the efficiency of treatment to have most of this activity concentrated in the second stage to the fluid.

Flows of waste water through an inline vortex mixture prior to venturi aspirator inducing the vortexing of the fluid promoting the mixing of ozone into a dissolved state.

The inline vortex mixture can be positioned from anything from 0 to 10 metres along the recirculation pipe away from the venturi aspirator outlets. As has been previously described, the liquid waste mixes with air from the head space within the upper portion the container and is blasted under pressure through colliding jets from vortex mixes feeding into the venturi aspirators that minimise droplet size maximizing surface area exposed to oxidation at a central position in the container directly opposite one another effecting in promoting maximum turbulence, mixing an opportunity for uptake of ozone, hydroxyl radical, and oxygen for treatment efficiency.

The fluid quality as it is being treated in the containers are monitored using multi-parameter sensors which are attached to an electronic electrical cable and housed in the vertical pipes which extends from a top of the container to just above the base of the container. The cable is controlled by automated electric drive motors to vary position sensors travelling from top to bottom of fluid levels during operation.

The effect of the pipe having a number of apertures means that it effectively is permeable and this allows enough constant flow through of fluid to measure water quality parameters reducing and preventing turbulence whereas the base of the vertical sensor permeable pipe is non-permeable and enlarged in diameter circumference although not specifically shown in the drawings.

This base acts as a recirculation and gravitation from vortex formation of fluid leaving the container recirculation outlet at the base.

The vertical sensor pipe in each case has a curve shape so as not to restrict the air gas fluid collision from the venturi aspirators outlets. While previously mentioned, there is used variable speed drives on all the circulation and transfer pumps. This allows for adjustment of flow rates, head and pressure. Water quality sensors are linked to control the variable speed drives. The air/gas recycling and recirculation is proportional to the adjustment in flow through variable speed drives along with the fluid.

Aspects of the water being censored includes PH, turbidity, dissolved ozone, oxidation reduction potential, dissolved oxygen, and as well the quantity of oxygen and ozone.

The invention can apply both to the apparatus, to a method of operating an apparatus, and to the resultant product resulting from the method of treatment and/or the apparatus.

Throughout this specification the purpose has been to illustrate the invention and not to limit this.

1. An apparatus for the purification of polluted and/or waste liquids utilizing an oxidative treatment of said polluted and/or waste liquids, said apparatus comprising:
a first container adapted to effect recirculation of the liquid while in the first container so that a head space is maintained above the liquid within the first container;
said recirculating liquid being drawn from the first container and being reintroduced into the first container through each of at least two jets aligned and positioned to direct said jets flow of liquid, so that this flow will impact against incoming liquid from at least one other of the jets;
means for introducing ozone into the recirculating liquid;
means for drawing the treated liquid from the first container;
wherein each jet including air suction means with an arrangement to integrate such sucked air into the liquid passing through the jet such that the air suction for each jet being connected and effecting a draw of such air from the head space within the container.

2. The apparatus of claim 1 further comprising means for introducing hydrogen peroxide and/or a coagulated polymer into the recirculating liquid.

3. The apparatus of claim 1 further comprising a second container, said second container adapted to receive treated water from said first container, said second container having means to effect recirculation of the liquid while in the second container so that a head space is maintained above the liquid within the second container, the recirculating liquid being drawn from the second container and reintroduced into the second container through each of two jets aligned to effect a contra flow one against the other of the liquid with respect to each jet of liquid, and each jet including air suction means with an arrangement to integrate such sucked air into the liquid passing through the jet, the air suction for each jet being connected and effecting a draw of such air from the head space within the container, and means introducing hydrogen peroxide, ozone and/or a polymer into the recirculating liquid of the second container, then drawing such treated liquid from the second container.

4. The apparatus of claim 1 wherein the jets are located at the top of the or each container within the respective head space or spaces above the liquid level.

5. The apparatus of claim 1 wherein each jet is positioned to introduce its fluid at or close to a lower most position within the container.

6. The apparatus of claim 1 further comprising a baffle plate located at bottom of the or each container to bounce bubbles of gas upwards.

7. The apparatus of claim 1 further comprising a liquid level sensor to maintain the head space within the respective container.

8. The apparatus of claim 1 wherein the liquid level in the or each container is approximately 80% of container volume until discharge.

9. The apparatus of claim 1 further including a cyclonic filter in either recirculation loop or inflowing liquid to separate suspended solids and reduce solids loading on sand/or zeolite filter and is flushed with inflow water.

10. The apparatus of claim 1 wherein the jets are venturi aspirators

11. The apparatus of claim 2 wherein the coagulated polymer is poly aluminium chloride.

12. The apparatus of claim 1 wherein air in the head space is drawn from the head space down through a conduit into an air inlet of a respective jet, the conduit being shaped with a narrowing cross sectional area from its inlet in the head space to the jet such that air being drawn through this is induced to be a vortex.

13. The apparatus of claim 7 wherein the fluid level sensors limit the upper fluid level automatically to a preset maximum height within the container and upper fluid level controls a predetermined airspace with the controlled air-space containing a selectable volume of air comprising the gasses released from the fluid and existent air within that space.

14. A method for oxidative treatment of waste liquids comprising the steps of introducing liquid to be treated into a container, effecting recirculation of the liquid while in the container so that a head space is maintained above the liquid within the first container, the recirculating liquid being drawn from the container and being reintroduced into the container through each of at least two jets aligned and positioned to direct its flow of liquid so that this flow will impact against incoming liquid from at least one other of the jets, and each jet including air suction means with an arrangement to integrate such sucked air into the liquid passing through the jet, the air suction for each jet being connected and effecting a draw of such air from the head space within the container, and means introducing ozone into the recirculating liquid, then drawing such treated liquid from the container.

15. The method of claim 14 further comprising the steps of introducing the liquid then first treated in the first said container into a second container, effecting recirculation of the liquid while in the second container so that a head space is maintained above the liquid within the second container, the recirculating liquid being drawn from the second container and reintroduced into the second container through each of two jets aligned to effect a contra flow one against the other of the liquid with respect to each jet of liquid, and each jet including air suction means with an arrangement to integrate such sucked air into the liquid passing through the jet, the air suction for each jet being connected and effecting a draw of such air from the head space within the container, and means introducing both hydrogen peroxide, ozone and/or a polymer into the recirculating liquid of the second container, then drawing such treated liquid from the second container.
